(19) United States
(12) Patent Application Publication
(10) Pub. No.: US 2005/0206515 A1
(43) Pub. Date: Sep. 22, 2005

(54) Systems for protection against intruders

(76) Inventors: Alexander Pakhomov, Yonkers, NY (US); Tim Goldburt, Chappaqua, NY (US)

Correspondence Address: Ilya Zborovsky, 6 Schoolhouse Way, Dix Hills, NY, 11746, US

(21) Appl. No.: 10/805,104

(22) Filed: Mar. 22, 2004

(51) Int. Cl. G08B 19/00

(52) U.S. Cl. 340/521; 340/566; 340/539.1

(57) ABSTRACT

A system for protection from intruders has at least two groups of sensors arranged so that the sensors in each of the groups are spaced from one another in a predetermined direction, while the groups of the sensors are spaced from one another in another direction which is substantially transverse to the one direction, the sensors being formed as seismic sensors, a single central control and processing unit arranged to receive unprocessed signals from the seismic sensors, at least one external alarm generating unit including a loudspeaker and a search light, at least one television camera associated with the alarm generating unit, and at least one phone line associated with the control and processing unit, the sensors, the alarm generating unit and the central control and processing unit being connected so that when an intruder is detected by at least one of the sensors of one of the groups of sensors, the alarm generating unit generates a loud voice warning by the loud speaker and generates a light by the search light, while the television camera records an image of the intruder in response to a command from the central control and processing unit which receives the signal from the at least one sensor, and when a sensor of the other of the groups of sensors additionally detects the intruder, the phone line is utilized to inform about a presence of the intruder.

### BACKGROUND OF THE INVENTION

The present invention relates to systems for protection against intruders.

Systems of the above mentioned general type are known in the art. Some of such systems are disclosed for example in U.S. Pat. Nos. 4,562,428; 4,780,872; 4,929,927; 5,726,627; 6,204,760; 6,278,365; 6,664,894. It is believed that the existing systems can be further improved.

### SUMMARY OF THE INVENTION

It is therefore an object of the present invention to provide a system for protection against intruders, which is a further improvement of the existing systems.

In keeping with these objects and with others which will become apparent hereinafter, one feature of the present invention resides, briefly stated, in a system for protection from intruders, comprising at least two groups of sensors arranged so that said sensors in each of said groups are spaced from one another in a predetermined direction, while said groups of said sensors are spaced from one another in another direction which is substantially transverse to said one direction, said sensors being formed as seismic sensors; a single central control and processing unit arranged to receive unprocessed signals from said seismic sensors; at least one external alarm generating unit including a loudspeaker and a search light; at least one television camera associated with said alarm generating unit; and at least one phone line associated with said control and processing unit, said sensors, said alarm generating unit and said central control and processing unit being connected so that when an intruder is detected by at least one of said sensors of one of said groups of sensors, said alarm generating unit generates a loud voice warning by said loud speaker and generates a light by said search light, while said television camera records an image of said intruder in response to a command from said central control and processing unit which receives said signal from said at least one sensor, and when a sensor of the other of said groups of sensors additionally detects the intruder, said phone line is utilized to inform about a presence of the intruder.

When the system is designed in accordance with the present invention, it constitutes a further improvement of the existing systems.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing the location of a plurality of seismic sensors of a system in accordance with the present invention;

FIG. 2 is a view schematically showing alarm generating units as well as a central control and processing unit of the inventive system; and

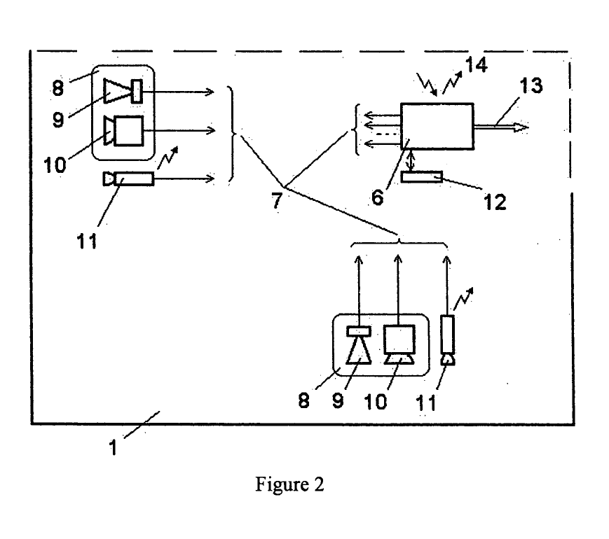

FIG. 3 is a view schematically showing a construction of one of the sensors.

### DESCRIPTION OF THE PREFERRED EMBODIMENTS

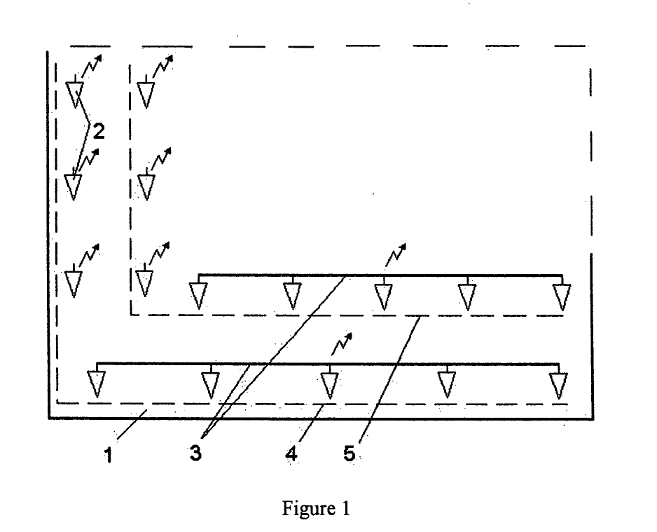

A system for protection against intruders as shown in FIG. 1 includes at least two groups of sensors identified with reference numeral 2 to protect an area 1 from intruders. The sensors are formed as seismic sensors and they can be formed as wireless sensors or wired sensors to correspondingly transmit signals wirelessly or through wires. The sensors 2 are arranged at least in two groups or strings 3 so as to form a first detection line 4 and a second detection line 5 as shown in FIG. 1. The sensors in each group are spaced from one another in one direction, while the groups of sensors are spaced from one another in another transverse direction. There can be two pairs of seismic groups or strings located so that one pair of the seismic sensor groups extends in one direction, while the other pair of the seismic sensors extends in a transverse direction to define the protected area 1.

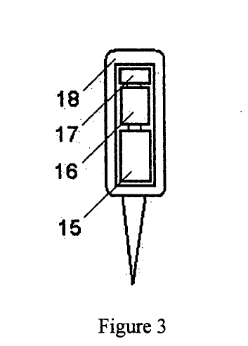

Each sensor can be formed as shown in FIG. 3. In particular it can include geophone 15, an electronic transmitter unit 16 which is in sleeping mode so as to use extremely low power, and a battery 17, all arranged in a case 18.

The system further has a central control and processing unit, which is identified as a whole with reference numeral 6. It can include a receiver, an amplifier, an analog-to-digital converter, a processing micro controller such as a microprocessor, a networking plate, etc.

The system is further provided with outdoor (external) alarm generating units 8. Each alarm-generating unit 8 includes a loudspeaker 9 and a search light 10. A television camera 11 is associated with each of the alarm generating units.

The central control and processing unit 6 is provided with a video recorder 12, a wire phone line 13 with or without access to Internet, or a wireless phone line 14.

The system for protection against intruders operates in the following manner.

When an intruder approaches a corresponding sensor the sensor produces a signal and sends it wirelessly or through wires to the central control and processing unit 6. The central control and processing unit 6 carries out analysis of the signal and determines whether the intruder is a human being or not, as disclosed for example, in our U.S. Pat. No. 6,529,130. If the intruder is a human being, then after the detection of the presence of the intruder, the corresponding alarm generating unit generates, through the loudspeaker loud messages: “Do not trespass”, “Do not enter”, “Private Property.” The search light 10 generates a light to search for the intruder, and the television camera 11 records the image of the intruder. If the second detection line 5 detects the presence of the intruder, the phone line 13 and/or 14 is utilized. The central control and processing unit 6 calls to three-four telephone numbers to inform about the occurrence of trespassing by an intruder.

It will be understood that each of the elements described above, or two or more together, may also find a useful application in other types of constructions differing from the types described above.

While the invention has been illustrated and described as embodied in systems for protection against intruders, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A system for protection from intruders, comprising at least two groups of sensors arranged so that said sensors in each of said groups are spaced from one another in a predetermined direction, while said groups of said sensors are spaced from one another in another direction which is substantially transverse to said one direction, said sensors being formed as seismic sensors; a single central control and processing unit arranged to receive unprocessed signals from said seismic sensors; at least one external alarm generating unit including a loudspeaker and a search light; at least one television camera associated with said alarm generating unit; and at least one phone line associated with said control and processing unit, said sensors, said alarm generating unit and said central control and processing unit being connected so that when an intruder is detected by at least one of said sensors of one of said groups of sensors, said alarm generating unit generates a loud voice warning by said loud speaker and generates a light by said search light, while said television camera records an image of said intruder in response to a command from said central control and processing unit which receives said signal from said at least one sensor, and when a sensor of the other of said groups of sensors additionally detects the intruder, said phone line is utilized to inform about a presence of the intruder.

2. A system as defined in claim 1; and further comprising a second pair of said two groups of sensors arranged so that said groups of said sensors of said second pair extends substantially transversely to said groups of said sensors of said first-mentioned pair to define a protected area.

3. A system as defined in claim 1, wherein each of said sensors includes a case, and also a geophone, an electronic transmitter unit which is ordinarily in a sleeping mode, and a battery, all located in said case.

4. A system as defined in claim 1, wherein said central control and processing unit includes a receiver, an amplifier, an analog-to-digital converter, a processing micro controller, and a networking plate.

5. A system as defined in claim 1, wherein said seismic sensors are formed as wireless sensors which wirelessly send said signal to said central control and processing unit.

6. A system as defined in claim 1, wherein said sensors are connected by wires to said central control and processing unit to send signal to the latter through said wires.

7. A system as defined in claim 1; and further comprising a video recorder associated with said central control and processing unit for video recording a presence of the intruder.

8. A system as defined in claim 1, wherein said central control and processing unit is operative to determine whether the intruder is a human being or not, so that the command is produced only when the intruder is a human being.
